(19) United States
(12) Patent Application Publication
(10) Pub. No.: US 2007/0157246 A1
(43) Pub. Date: Jul. 5, 2007

(54) Sports Broadcast Scheduler

(75) Inventor: Damon Phillips, Broadlands, VA (US)

Correspondence Address: JACKSON & CO., LLP, 6114 LA SALLE AVENUE, #507, OAKLAND, CA, 94611-2802, US

(73) Assignee: SPORTS TV INSIDER, LLC, Ashburn, VA (US)

(21) Appl. No.: 11/613,688

(22) Filed: Dec. 20, 2006

Related U.S. Application Data
(60) Provisional application No. 60/753,572, filed on Dec. 23, 2005.

(51) Int. Cl. H04N 7/10; H04N 7/025; G06F 13/00; H04N 5/445; G06F 3/00

(52) U.S. Cl. 725/46; 725/34; 725/35

(57) ABSTRACT

A customized sports broadcast schedule is generated. Rankings are assigned to teams based on performance, popularity, and/or season stage. A customer-specific psychographic profile is generated based on customer location and/or customer preferences. The customer-specific sports broadcast schedule is generated based on the customer-specific psychographic profile and assigned rankings.

### PRIORITY

This application claims the benefit of priority to U.S. provisional patent application Ser. No. 60/753,572, filed Dec. 23, 2005, which is hereby incorporated by reference.

### BACKGROUND

1. Field of the Invention

The invention relates to sports broadcast scheduling, and particularly to customized reports based on customer-specific psychographic profiles and team rankings.

2. Description of the Related Art

Sports-themed establishments such as sports bars and restaurants, and at-home television viewers and internet users, as well as ordinary consumers, have seemingly myriad choices of sporting events to choose from. For the sports-themed establishments, either an employee has to spend a great deal of time figuring out which channels to set various televisions to, or the televisions end up by default on channels that are not showing the premiere local or national sporting events. In the former case, selecting channels for every television as events end can be a full time endeavor, particularly at establishments that subscribe to hundreds of channels. In the latter case, customers either have to interrupt socializing to remind the establishment manager that a certain event is not being shown and request a channel change, or customers may simply go to different establishments that tend to show optimal sports events schedules without the need to remind the establishment manager. None of these options is good for business. It is desired to have a reliable schedule generated in advance that establishments can use. Such can also be desirable for at-home television viewers or consumers or business owners carrying mobile products, as described in detail below.

It is recognized in the present invention that sports establishments and consumers will differ in the sports broadcast events respectively that their customers or that they themselves or their families and friends wish to view. Thus, simply preparing a schedule of national or world events and distributing it to establishments throughout the country or world will not result in specific establishments or consumers getting schedules that are optimal for them. As sports schedules are dynamic, preparing a schedule based on past viewing history is insufficient. It is desired to have a technique for generating a sports broadcast schedule that uniquely takes into account specific, dynamic parameters relating to sports establishment and/or at home or mobile consumers.

### SUMMARY OF THE INVENTION

A method is provided for generating a customized sports broadcast schedule. Rankings are assigned to teams based on performance, popularity, and/or season stage. A customer-specific psychographic profile is generated based on customer location and/or customer preferences. A customer-specific sports broadcast schedule is generated based on the customer-specific psychographic profile and assigned rankings.

Teams may be excluded which have rankings below a certain threshold ranking, and/or teams may be prioritized which have ranking above a same or different threshold ranking. Teams may be excluded which have broadcast ratings below a certain threshold rating and/or team may be prioritized which have broadcast ratings above a same or different threshold rating.

The customer-specific sports broadcast schedule may be divided into multiple time periods.

The generating of the customer-specific sports broadcast schedule may involve generating a master schedule including substantially all or most available sports broadcast events, and then removing events from the master schedule that fail certain criteria and/or selecting events that pass certain criteria.

The generating of the customer-specific sports broadcast schedule may include generating both a local broadcast schedule which takes into account customer location, and a national broadcast schedule which does not take into account customer location. The local and national broadcast schedules may then be combined.

The generating of the customer-specific psychographic profile may be based at least in part on customer preferences which may include subjective criteria received from the customer other than or in addition to information relating to past viewing history. The generating of the customer-specific psychographic profile may also be based at least in part on customer location, such that teams within a same geographic region as the customer receive enhanced prioritization.

The rankings may be based at least in part on performance, which may be based on win/loss record, Las Vegas odds, and/or another professional organization ranking. The rankings may be based at least in part on popularity, which may be based on one or more polls, sales of merchandise, vote getting, away game attendance, and/or another professional organization ranking. The rankings may be based at least in part on season stage, wherein greater proximity to end of season may be given an enhanced ranking.

The schedule may be provided electronically or wirelessly to customers.

A customized sports broadcast schedule report is also provided which may be distributed to a customer electronically and/or wirelessly. The report includes a schedule of selected sports broadcast events generated based on a customer-specific psychographic profile and assigned team rankings. The psychographic profile is based on customer location and/or customer preferences, while the assigned team rankings are based on performance, popularity and/or season stage. The report may further be provided as otherwise described herein.

One or more processor readable storage devices are also provided with processor readable code embodied thereon for programming one or more processors to perform a method of generating a customized sports broadcast schedule as otherwise described herein.

### BRIEF DESCRIPTION OF THE DRAWINGS

FIG. 1 is a flow diagram that illustrates a method in accordance with an embodiment.

FIG. 2 illustrates criteria for assigning rankings to NBA teams in accordance with an embodiment.

FIGS. 3A-3E illustrate a complete daily schedule of sports broadcast events in accordance with an embodiment.

FIGS. 4A-4E illustrate recommendations provided for five different time periods of a day corresponding to the complete daily schedule of FIGS. 3A-3E in accordance with an embodiment.

FIG. 5 illustrates a mobile product in accordance with an embodiment.

### DETAILED DESCRIPTION OF THE PREFERRED EMBODIMENTS

A method and apparatus are provided for developing and distributing customized sports television schedules, particularly for public locations such as restaurants and bars, and also for at-home and mobile consumers. An algorithm is provided on one or more digital storage media for providing instructions to a processor which receives inputs and computes and outputs recommendations for the best sporting events to watch based on one or more and potential a variety of many variables. The recommendations are computed and provided based on psychographic profiles of customers and/or customer locations or clientele. In a preferred embodiment, the recommendations will be unique to each customer or establishment, or at least the computations will be uniquely based on a customer- and/or location-specific psychographic profile.

A psychographic profile involves more than just past viewing history. Preferably, geography is taken into account. For example, those teams that are within a same geographical region as the customer location may have an enhanced prioritization. Preferences provided by the customer location, whatever they may be, can also be included as part of a psychographic profile. This provides a subjective element. Objective rankings (wins and losses in divisions or leagues) and/or rating (viewership, past popularity) may also be taken into account as part of a psychographic profile.

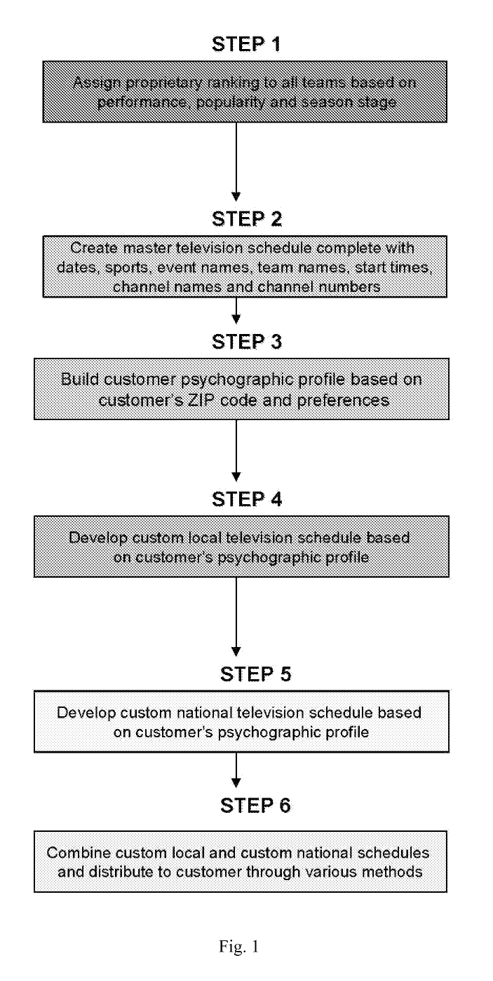

FIG. 1 illustrates a method includes step 1 through step 6 in accordance with an embodiment. At step one, rankings are assigned to teams based on performance, popularity and/or season stage. Ranking may be based on one, two or all three of these criteria. Other criteria may be used in addition to or instead of any of these. For example, a team or player may have an enhanced ranking because he or she or it is about to break a record, or a particular pitcher may be on the mound for a certain baseball game, or a team may have decreased ranking if a star player is injured, among other possible criteria.

Performance can be based on win/loss record and/or Las Vegas odds to win, particularly for NFL, NBA, MLB and NHL teams and events. Computer polls and media polls may also be used, particularly for college football, which may use Vegas odds for winning the national championship or becoming a bowl team or BCS team. Polls, Vegas odds to win the national title during March Madness or to make the 64 team field or the NIT, win/loss record and subjective conference ratings may be used particularly for college basketball. Performance rankings may be also increased or decreased based on which conference or division a team is in, e.g., whether the conference or division is more or less competitive relative to the rest of the league, and notwithstanding their win/loss record, whether they are leading a division or conference, or trailing one or more teams.

Performance at particular events may be taken into account, e.g., the Raiders may have a higher performance ranking for Monday Night Football than for Sunday football. Many teams may win more often at home than on the road and as such the home field advantage may be generally taken into account. Many other specific criteria may be taken into account, e.g., team may win more or less often on natural grass than on artificial turf, certain poker players may be better at no-limit Texas Hold'em than Pot Limit Omaha, horses, trainers and jockeys may win more often on turf than on dirt, and any of myriad parameters may be taken into account when determining the performance ranking, while it may also be kept very simple such as merely upon win/loss record or anywhere in between.

Popularity can be based on published or private polls, pro bowl top vote getters, top selling player jerseys, and/or number of web site hits, particularly for NFL football. Away game attendance figures may also be used, particularly for NBA, NHL, MLB and NFL teams. Subjective team and conference ratings may be used particularly for college football and college basketball. A combined score for two or more teams participating in an event may be used.

With regard to season stage in one embodiment, seasons are broken down into five distinct stages within which weighting of performance and popularity are taken into account. The season may be broken into any number of stages, while generally the closer to the end of the season, the higher the assigned ranking.

At step two, a master television schedule is created. The master schedule is a complete schedule of events for a day or other time period. The completeness of the schedule may be based on whether a particular customer is eligible to receive certain broadcasts, or it may be a same universal complete events schedule for all customers, or for all customers in regions of the country. The master schedule may include dates, sports, event names, team names, start times, channel names and/or channel numbers. The master schedule may be assembled based on information available in the public domain or a syndicated television schedule.

At step three, a customer psychographic profile may be built based on a customer's location such as according to their zip code or other address information such as city, state, or region. The metropolitan statistical area or MSA of a customer's zip code may be used. The psychographic profile of the customer may also be based on customer-specific preferences. For example, a bar in Chicago may prefer to get Yankee games, or may prefer college basketball over NHL hockey. Preferences may be communicated by customers, and/or they may be inferred based on customer actions or polls of potential customers. The psychographic profile may be based on both location and one or more preferences. Other data that may be used in a psychographic profile include prioritizing one or more of the following: college and pro teams within the customer's MSA, college and pro teams covered by a newspaper in a customer's MSA, college and pro teams that play pre-season games in a customer's MSA, college and pro teams with radio or television affiliates in a customer's MSA, local and national television ratings of sports and teams in customer's MSA, and/or a customer's favorite sports, teams, events, players or participants, sportscasters, commentators, owners, venues, weather, time of day or season of the event at the event location, degree of extreme nature of the event, and any write-in preferences a customer may provide.

At step four, a custom local television schedule based on the customer's psychographic profile is developed. In one embodiment, televised events of teams identified in step three are stored if they meet a pre-determined minimum television rating and/or their ranking assigned in step one meets a pre-determined minimum. Stored events may be placed into distinct time periods, e.g., two or more of pre-lunch, lunch, happy hour, dinner, and late night, until a predetermined maximum is reached for each time period.

At step five, a custom national television schedule is developed based the customer's psychographic profile. Televised events are stored for the most popular sports if they meet predetermined minimum television rating and/or their ranking in step one meets a pre-determined minimum. Just as with step four, stored events may be placed into distinct time periods, e.g., two or more of pre-lunch, lunch, happy hour, dinner, and late night, until a predetermined maximum is reached for each time period.

At step six, the custom local and custom national television schedules are combined and distributed. The method of distribution may be internet, electronic, email, fax, wireless, fiber optics, satellite, cable, microwave, wire transmission, radio and/or broadcast.

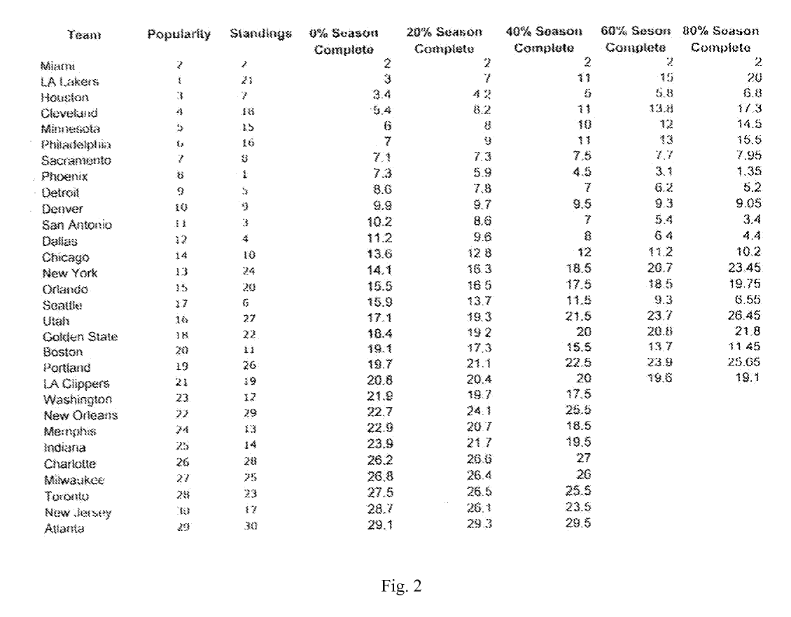

FIG. 2 illustrates exemplary criteria for assigning rankings to NBA teams in accordance with an embodiment. The NBA teams are listed in the left-most column of the table of FIG. 2. For each team, its popularity relative to the other teams is provided, e.g., the Lakers are ranked first in popularity in the table of FIG. 2, while the Miami Heat are ranked second, and so on down to the New Jersey Nets in 30^{th} place. Each team is indicated as being from 1^{st} to 30^{th} in the standings based on win/loss record. The final five columns take into account season stage.

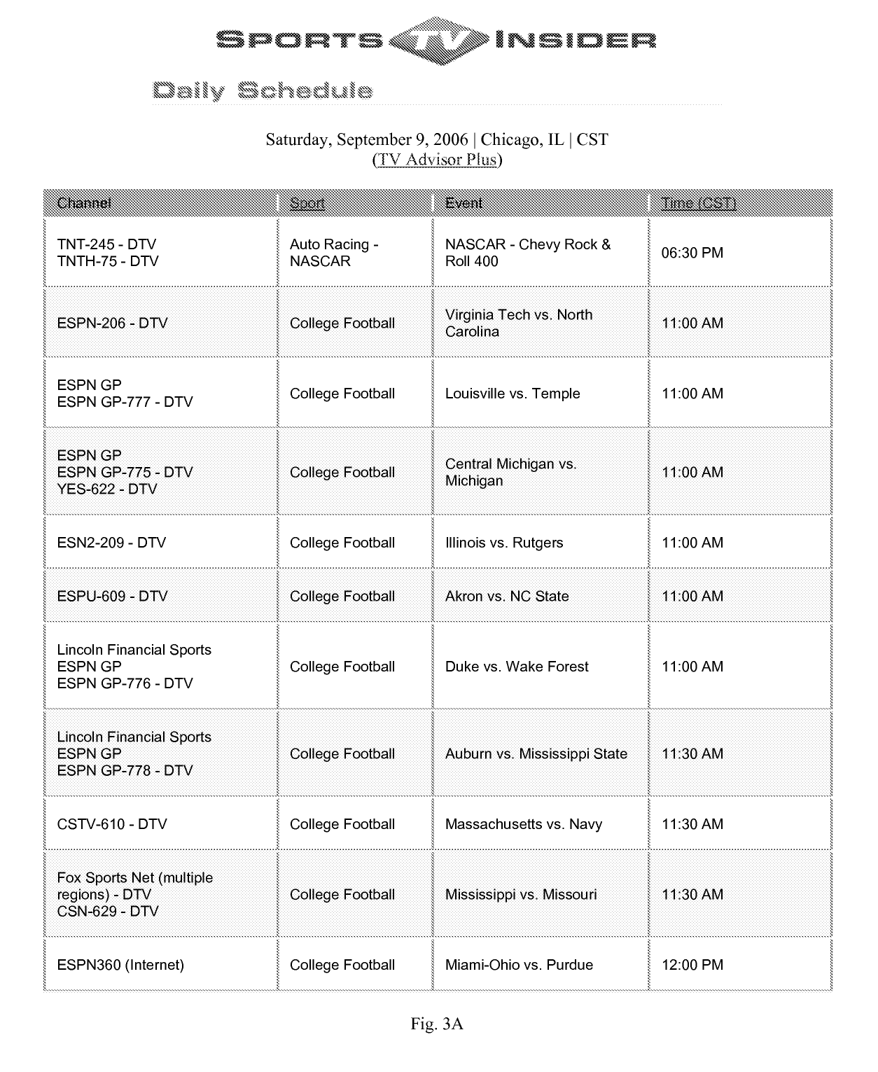

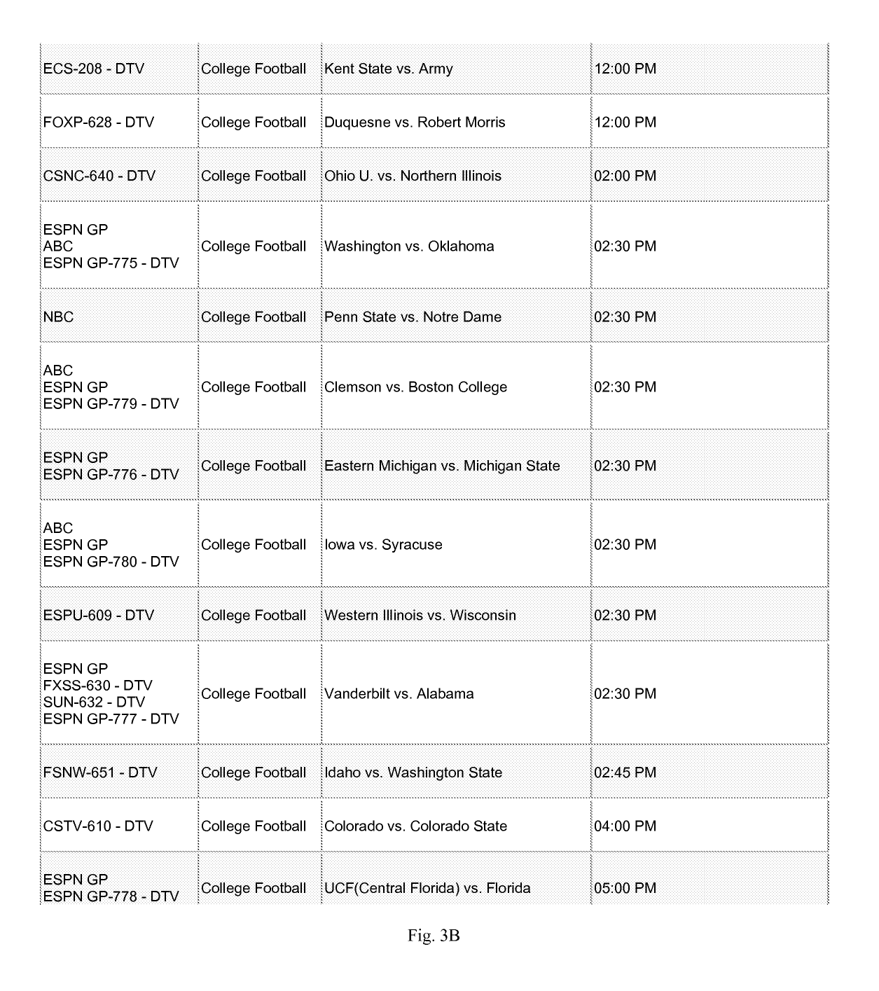

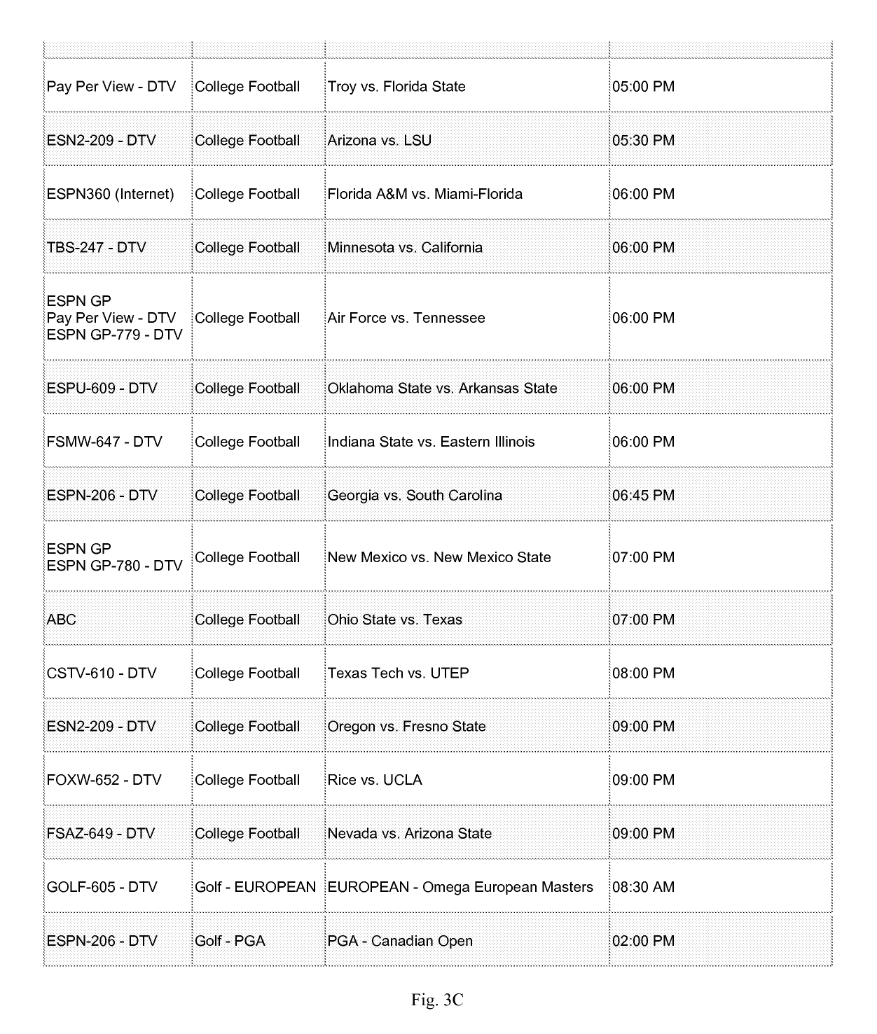

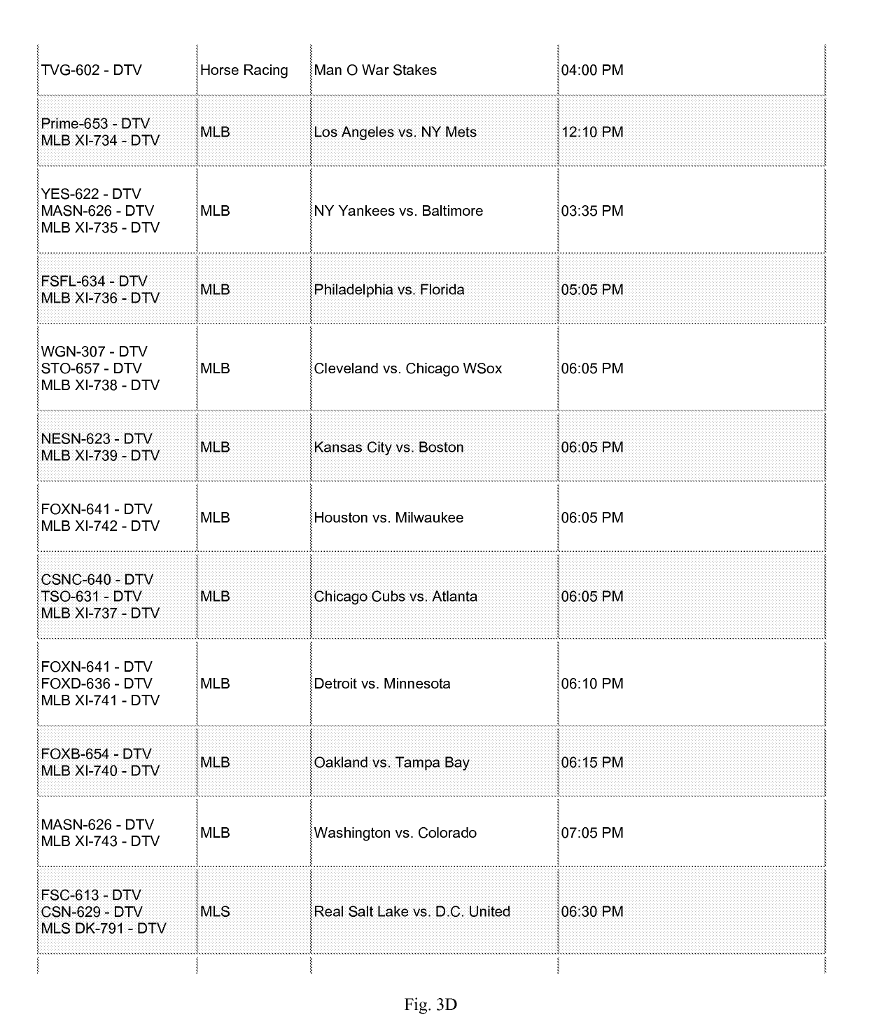

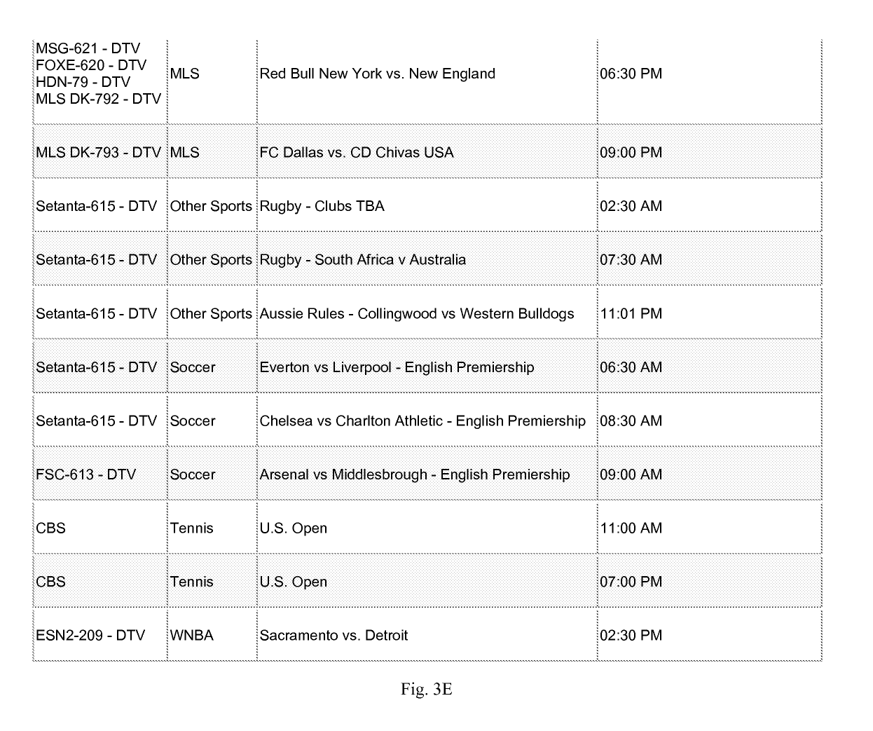

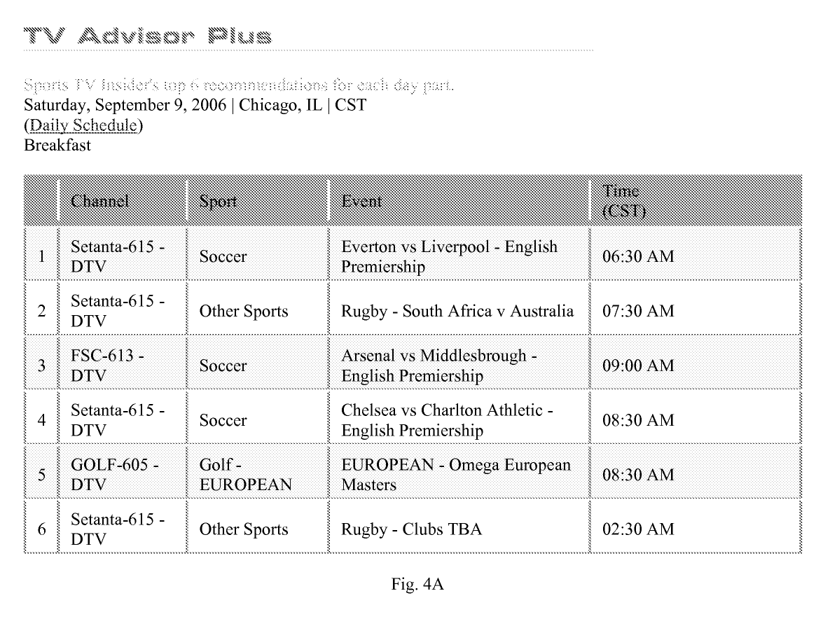

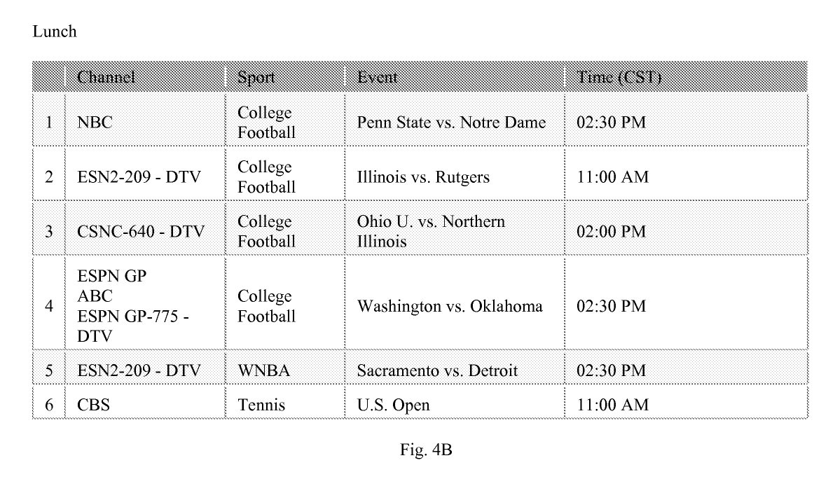

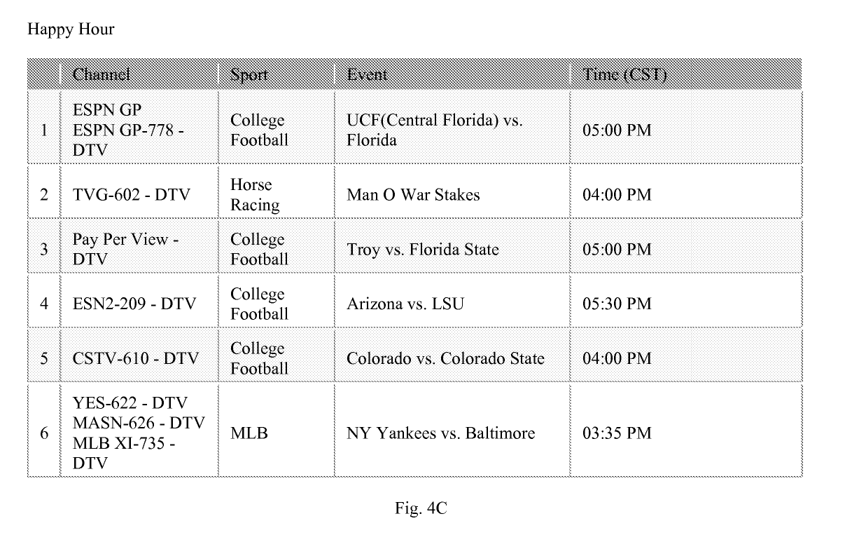

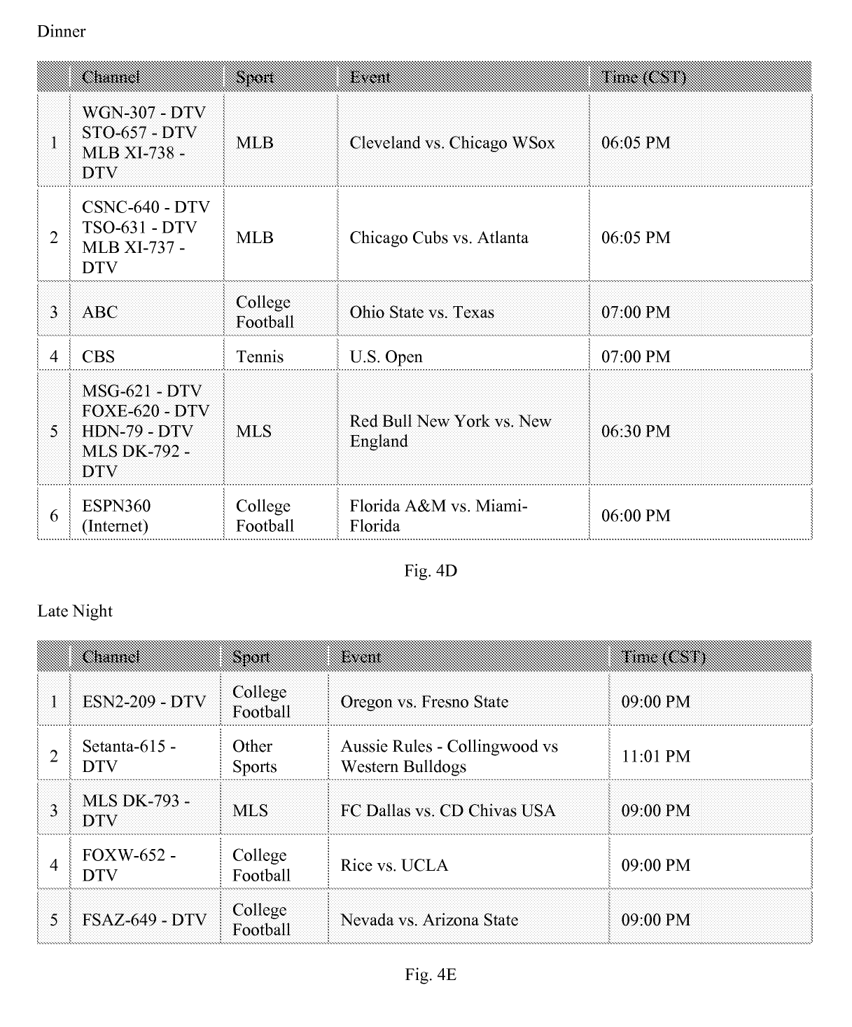

FIGS. 3A-3E illustrate a complete daily schedule of sports broadcast events. This schedule can be provided to a customer who wishes to be able to choose differently from the recommendations provided at FIGS. 4A-4E either at the beginning of the event or when an event becomes lop-sided. However, its main purpose is to provide a base schedule from which to choose based on the formula provided herein, or de-select or narrow down to recommended events.

FIGS. 4A-4E illustrate recommendations provided for five different time periods of a day corresponding to the complete daily schedule of FIGS. 3A-3E. The events listed at FIGS. 4A-4E are those that were selected among other choices for each time period as shown on the complete schedule of FIGS. 3A-3E. The psychographic profile of a specific customer, and assigned rankings of the teams and events available, led to choosing the top five or six events for each time period over others that were not selected nor listed in the recommended schedule.

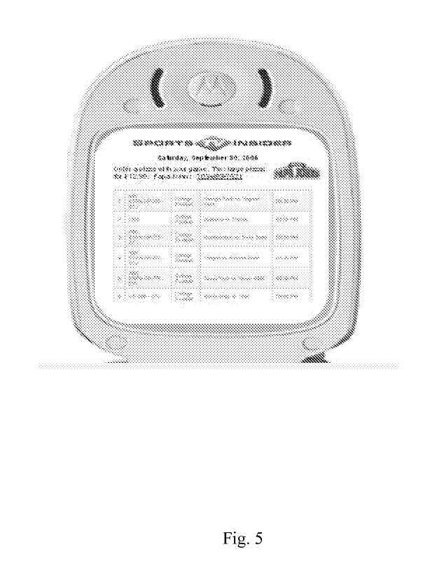

FIG. 5 illustrates a mobile product. This product, as well as that which has been described above and the further examples provided below, may be for general consumers who simply wish to know what sports events are available or for restaurants, bars and other businesses that might show sports events on one more television screens. With regard to consumers, the schedule may be uploaded to an existing mobile device such as a mobile phone, Blackberry™ PDA, portable game device, laptop computer, satellite radio receiver, iPod™ or other MP3 or MP3-like music player, or a medical device such as a flow meter for asthmatics or cardiac monitoring device for heart patients, or transmitted into consumers' homes directly onto their television sets or internet-ready or web-enabled devices. Alternatively, a consumer or business owner may purchase and utilize a stand-alone portable device just as a mobile sports broadcast scheduler.

The mobile product may include only a subset of the national schedule illustrated at FIGS. 3A-3E or only a subset of the schedule of selected events of FIGS. 4A-4E, or depending on computing power and display size, the mobile product may provide the entire schedules available with other products. As an example, mobile customers might receive only the top six, top eight or top ten events, which would be easily displayable. It may be possible to click on or touch-screen the event to get further information about the event, teams or players participating, weather, fantasy football information, latest Vegas line, other events impacting this event such as football games in a same division or including teams in competition for a same wildcard spot, etc.

In addition, the mobile product preferably allows consumers to select their favorite teams. This can be one of the preferences described above, or may be a special feature, e.g., of a particular team's mobile product. The product housing can have, e.g., a 49ers logo or NASCAR logo, and be set-up to provide events for those particular organizations. The schedules provided can be based not only on geography, ranking and rating, but also on one or more random or whimsical preferences, e.g. a consumer may live in Virginia, but may be a 49ers fan. In that case, the scheduler can be set-up to base the schedules it shows, as well as any other information about upcoming games, news, player profiles, etc., around the preference for the 49ers and teams in their division or conference. The set-up can be balanced so that zip code is another factor or so that zip code only matters in figuring out time zone and channels, e.g., in instances in the latter case where the consumer or business is wholly uninterested in local sports teams.

The mobile product of FIG. 5 can also include an advertisement, e.g., for pizza with a phone number to a local pizza shop. This feature would be based at least in part on zip code or other address criteria, and can also be based on a consumer's preference for pizza, or for a particular pizza shop in town, or other delivery or take-out service preference, or an on-line sportsbook for consumers in Nevada or other locations where sports betting is permitted.

An example algorithm is provided below. The algorithm shows multiple steps, routines, sub-routines for arriving at schedules provided to consumers and/or businesses of recommended events based on one or more of the criteria mentioned above such as rating, ranking, preference and/or location. In summary, a first step would eliminate events of little or no interest based on preference, low tv rating, bad record, or otherwise. A second step would find favorite teams or series in strong interest sports. Events may be displayed in order of favorites, ratings, or otherwise, and this list may be abridged based on other criteria described herein or to a top five, e.g. In a third step, events are found in strong interest sports and displayed. In steps four and five, favorite teams and best events are found and displayed in “somewhat interested” sports, or those a consumer or business has indicated some interest, but not strong interest or no interest. At step six, weaker events are searched and displayed for strong interest sports, e.g., a football game involving two losing, non-local teams. Then, weaker events in somewhat interested sports may be searched and displayed if a maximum number of events for display has not already been reached. The algorithm can be specifically illustrated as follows, or otherwise configured according to the above or equivalently or alternatively in view of the above or below as understood by those skilled in the art:

Step 1 (Get Rid of “Little or No Interest” Sports)

IF sport equals “Little or No Interest” AND event has tv rating less than 5.0 THEN remove from universe

IF sport equals “Little or No Interest” AND event has tv rating 5.0 or greater THEN store in Cell A (if not a NFL, NBA, MLB, NHL, CFB, CBK)

IF sport equals “Little or No Interest” AND event has tv rating 10.0 or greater THEN store in Cell A (if NFL, NBA, MLB, NHL, CFB, CBK)

Step 2a (Find Favorite Teams/Series in “Strong Interest” Sports)

IF sport equals “Strong Interest” AND event equals “Favorite” THEN store in Cell B

IF sport equals “Strong Interest” AND has no sub-categories THEN store in Cell B

Step 2b (Display Events)

Display “Cell B” events in order of TV rating and then favorite team order (store in Cell Z)

IF events equal 10 THEN finished

Step 3a (Find Best Events in “Strong Interest” Sports)

IF sport equals “Strong Interest” THEN store events that meet following criteria: any NFL team; NBA, MLB or NHL team with top 16 STV meter; College Football/Basketball team with top 50 STV meter in Cell C

Accept in following order (STV meter ranking relative to available events that day)—if favorite team selected

a1. NFL, NBA, MLB, NHL Teams—Best STV meter in #1 favorite team division (if already selected then 2nd best stv meter in #1 favorite team division)

a2. College Football/Basketball TEams—Best STV meter in #1 favorite team conference (if already selected then 2nd best stv meter in #1 favorite team division)

b1. NFL, NBA, MLB, NHL Teams—2nd Best STV meter in #1 favorite team division (if already selected then 2rd best stv meter in #1 favorite team division)

b2. College Football/Basketball Teams—2nd Best STV meter in #1 favorite team conference (if already selected then 3rd best stv meter in #1 favorite team division)

c1. NFL, NBA, MLB, NHL Teams—Best STV meter in sport (if already selected then 2nd best stv meter in sport)

c2. College Football/Basketball TEams—Best STV meter in sport (if already selected then 2nd best stv meter in sport)

d1. NFL, NBA, MLB, NHL Teams—2nd Best STV meter in sport (if already selected then 3rd best stv meter in sport)

d2. College Football/Basketball TEams—2nd Best STV meter in sport (if already selected then 3rd best stv meter in sport)

Repeat STEP 3a if multiple favorite teams

if no favorite team selected then

Next best STV meter in sport

Next best STV meter in sport

Next best STV meter in sport

Next best STV meter in sport

Step 3b (Display Events)

Display “Cell C” events after “Cell Z” in order of TV rating and then STV meter order (store in Cell Z)

Add “Cell A” to “Cell Z” (if Cell Z our rates Cell C then bump Cell A to top

IF events equal 10 THEN finished

Step 4a (Find Favorite Teams/Series in “Somewhat Interested” Sports)

IF sport equals “Somewhat Interested” AND event equals “Favorite” THEN store in Cell D

IF sport equals “Somewhat Interested” AND has no sub-categories THEN store in Cell D

Step 4b (Display Events)

Display “Cell D” events after “Cell Z” in order of TV rating and then favorite team order (store in Cell Z)

IF events equal 10 THEN finished

Step 5a (Find Best Events in “Somewhat Interested” Sports)

IF sport equals “Somewhat Interested” THEN store events that meet following criteria: any NFL team; NBA, MLB or NHL team with top 16 STV meter; College Football/Basketball team with top 50 STV meter in Cell E

Accept in following order (STV meter ranking relative to available events that day)

a1. Pro Teams—Best STV meter in #1 favorite team division (if already selected then 2nd best stv meter in division)

a2. College Teams—Best STV meter in #1 favorite team conference (if already selected then 2nd best stv meter in division)

b1. Pro Teams—2nd Best STV meter in #1 favorite team division (if already selected then 2rd best stv meter in division)

b2. College Teams—2nd Best STV meter in #1 favorite team conference (if already selected then 3rd best stv meter in division)

c1. Pro Teams—Best STV meter in #1 favorite team sport (if already selected then 2nd best stv meter in sport)

c2. College Teams—Best STV meter in sport (if already selected then 2nd best stv meter in sport)

Repeat STEP 5a if multiple favorite teams

Step 5b (Display Events)

Display “Cell E” events after “Cell Z” in order of TV rating and then STV meter order (store in Cell Z)

IF events equal 10 THEN finished

Step 6a (Find Weaker Events in “Strong Interest” Sports)

IF sport equals “Strong Interest” THEN store events that meet following criteria: any NFL, NBA, MLB, NHL, College Football/Basketball team in Cell F

Accept in following order (STV meter ranking relative to available events that day)

a1. Pro Teams—Next best STV meter in sport

a2. College Teams—Next best STV meter in sport

b1. Pro Teams—Next best STV meter in sport

b2. College Teams—Next best STV meter in sport

Step 6b (Display Events)

Display “Cell F” events after “Cell Z” in order of TV rating and then STV meter order (store in Cell Z)

IF events equal 10 THEN finished

Step 7a (Find Weaker Events in “Somewhat Interested” Sports)

IF sport equals “Strong Interest” THEN store events that meet following criteria: any NFL, NBA, MLB, NHL, College Football/Basketball team in Cell G

Step 7b (Display Events)

Display “Cell G” events after “Cell Z” in order of TV rating and then STV meter order (store in Cell Z)

IF events equal 10 THEN finished

IF events less than 10 goto to STEP 6a

Need manual auto-promote event function

The following background US patents and US published patent applications are, in addition to the Background, Summary of the Invention, Drawings, and Brief Description of the Drawings, and Abstract, hereby incorporated by reference as disclosing alternative embodiments:

U.S. Pat. Nos. 6,928,653, 6,898,762, 6,817,028, 6,760,537, 6,756,997, 6,732,367, 6,728,967, 6,728,966, 6,701,527, 6,675,385, 6,604,240, 6,564,379, 6,564,378, 6,563,515, 6,549,719, 6,526,577, 6,481,011, 6,477,705, 6,463,206, 6,442,755, 6,341,374, 6,341,195, 6,321,381, 6,268,849, 6,247,176, 6,160,546, 6,154,203, 6,137,950, 6,137,549, 6,075,575, 6,072,520, 6,064,376, 6,052,145, 6,049,652, 5,988,078, 5,974,222, 5,970,206, 5,959,688, 5,949,471, 5,918,905, 5,886,746, 5,870,150, 5,828,419, 5,801,787, 5,734,786, 5,694,176, 5,673,089, 5,640,484, 5,532,754, 5,410,367, and 4,496,171; and

United States published patent applications nos. 20050278768, 20050278734, 20050251836, 20050251828, 20050229215, 20050229214, 20050105881, 20050058433, 20050028208, 20050008333 and 20040210935.

While an exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the appended claims and structural and functional equivalents thereof.

In addition, in methods that may be performed according to preferred embodiments herein and that may have been described above, the operations have been described in selected typographical sequences. However, the sequences have been selected and so ordered for typographical convenience and are not intended to imply any particular order for performing the operations, except for those where a particular order may be expressly set forth or where those of ordinary skill in the art may deem a particular order to be necessary.

What is claimed is:

1. A method of generating a customized sports broadcast schedule, comprising:
(a) assigning rankings to teams based on performance, popularity, or season stage, or combinations thereof;
(b) generating a customer-specific psychographic profile based on customer location or customer preferences or both; and
(c) generating a customer-specific sports broadcast schedule based on the customer-specific psychographic profile and assigned rankings.

2. The method of claim 1, further comprising excluding teams with rankings below a certain threshold ranking, or prioritizing teams with ranking above a same or different threshold ranking, or both.

3. The method of claim 1, further comprising excluding teams with broadcast ratings below a certain threshold rating or prioritizing teams with broadcast ratings above a same or different threshold rating, or both.

4. The method of claim 1, further comprising dividing the customer-specific sports broadcast schedule into multiple time periods.

5. The method of claim 1, wherein the generating of the customer-specific sports broadcast schedule comprises:
(i) generating a master schedule comprising substantially all or most available sports broadcast events, and
(ii) removing events from the master schedule that fail certain criteria or selecting events that pass certain criteria, or both.

6. The method of claim 1, wherein the generating of the customer-specific sports broadcast schedule comprises generating both a local broadcast schedule which takes into account customer location, and a national broadcast schedule which does not take into account customer location, and wherein the generating of the customer-specific sports broadcast schedule comprises combining the local and national broadcast schedules.

7. The method of claim 1, wherein the generating of the customer-specific psychographic profile is based at least in part on customer preferences.

8. The method of claim 7, wherein the customer preferences include subjective criteria received from the customer other than or in addition to information relating to past viewing history.

9. The method of claim 1, wherein the generating of the customer-specific psychographic profile is based at least in part on customer location, such that teams within a same geographic region as the customer receive enhanced prioritization.

10. The method of claim 1, wherein the rankings are based at least in part on performance, which is based on win/loss record, Las Vegas odds, or another professional organization ranking, or combinations thereof.

11. The method of claim 1, wherein the rankings are based at least in part on popularity, which is based on one or more polls, sales of merchandise, vote getting, away game attendance, or another professional organization ranking, or combinations thereof.

12. The method of claim 1, wherein the rankings are based at least in part on season stage, wherein greater proximity to end of season is given an enhanced ranking.

13. The method of claim 1, further comprising electronically or wirelessly distributing the customer-specific broadcast schedule to the customer, or both.

14. A customized sports broadcast schedule report which is distributed to a customer electronically or wirelessly, or both, includes a schedule of selected sports broadcast events generated based on a customer-specific psychographic profile and assigned team rankings, wherein the psychographic profile is based on customer location or customer preferences, or both, and the assigned team rankings are based on performance, popularity or season stage, or combinations thereof.

15. The report of claim 14, wherein teams with rankings below a certain threshold ranking are specifically excluded, or teams with ranking above a same or different threshold ranking are specifically prioritized, or both.

16. The report of claim 14, wherein teams with broadcast ratings below a certain threshold rating are specifically excluded, or teams with broadcast ratings above a same or different threshold rating are specifically prioritized, or both.

17. The report of claim 14, comprising multiple subsets of events categorized each by a different time period.

18. The report of claim 14, comprising a master schedule including substantially all or most available sports broadcast events, and an abridged schedule generated from the master schedule by removing events from the master schedule that fail certain criteria or selecting events that pass certain criteria, or both.

19. The report of claim 14, comprising a local broadcast schedule which takes into account customer location, and a national broadcast schedule which does not take into account customer location.

20. The report of claim 14, wherein the customer-specific psychographic profile is based at least in part on customer preferences.

21. The report of claim 20, wherein the customer preferences include subjective criteria received from the customer other than or in addition to information relating to past viewing history.

22. The report of claim 14, wherein the customer-specific psychographic profile is based at least in part on customer location, such that teams within a same geographic region as the customer receive enhanced prioritization.

23. The report of claim 14, wherein the rankings are based at least in part on performance, which is based on win/loss record, Las Vegas odds, or another professional organization ranking, or combinations thereof.

24. The report of claim 14, wherein the rankings are based at least in part on popularity, which is based on one or more polls, sales of merchandise, vote getting, away game attendance, or another professional organization ranking, or combinations thereof.

25. The report of claim 14, wherein the rankings are based at least in part on season stage, wherein greater proximity to end of season is given an enhanced ranking.

26. The report of claim 14, comprising an electronic report.

27. One or more processor readable storage devices having processor readable code embodied thereon, said processor readable code for programming one or more processors to perform a method of generating a customized sports broadcast schedule, wherein the method comprises:
(a) assigning rankings to teams based on performance, popularity, or season stage, or combinations thereof;
(b) generating a customer-specific psychographic profile based on customer location or customer preferences or both; and
(c) generating a customer-specific sports broadcast schedule based on the customer-specific psychographic profile and assigned rankings.

28. The one or more storage devices of claim 27, wherein the method further comprises excluding teams with rankings below a certain threshold ranking, or prioritizing teams with ranking above a same or different threshold ranking, or both.

29. The one or more storage devices of claim 27, wherein the method further comprises excluding teams with broadcast ratings below a certain threshold rating or prioritizing teams with broadcast ratings above a same or different threshold rating, or both.

30. The one or more storage devices of claim 27, wherein the method further comprises dividing the customer-specific sports broadcast schedule into multiple time periods.

31. The one or more storage devices of claim 27, wherein the generating of the customer-specific sports broadcast schedule comprises:
(i) generating a master schedule comprising substantially all or most available sports broadcast events, and
(ii) removing events from the master schedule that fail certain criteria or selecting events that pass certain criteria, or both.

32. The one or more storage devices of claim 27, wherein the generating of the customer-specific sports broadcast schedule comprises generating both a local broadcast schedule which takes into account customer location, and a national broadcast schedule which does not take into account customer location, and wherein the generating of the customer-specific sports broadcast schedule comprises combining the local and national broadcast schedules.

33. The one or more storage devices of claim 27, wherein the generating of the customer-specific psychographic profile is based at least in part on customer preferences.

34. The one or more storage devices of claim 33, wherein the customer preferences include subjective criteria received from the customer other than or in addition to information relating to past viewing history.

35. The one or more storage devices of claim 27, wherein the generating of the customer-specific psychographic profile is based at least in part on customer location, such that teams within a same geographic region as the customer receive enhanced prioritization.

36. The one or more storage devices of claim 27, wherein the rankings are based at least in part on performance, which is based on win/loss record, Las Vegas odds, or another professional organization ranking, or combinations thereof.

37. The one or more storage devices of claim 27, wherein the rankings are based at least in part on popularity, which is based on one or more polls, sales of merchandise, vote getting, away game attendance, or another professional organization ranking, or combinations thereof.

38. The one or more storage devices of claim 27, wherein the rankings are based at least in part on season stage, wherein greater proximity to end of season is given an enhanced ranking.

39. The one or more storage devices of claim 27, wherein the method further comprises electronically or wirelessly distributing the customer-specific broadcast schedule to the customer, or both.
